(19) United States
(12) Patent Application Publication
(10) Pub. No.: US 2015/0226386 A1
(43) Pub. Date: Aug. 13, 2015

(54) HIGH-POWER, LASER-DRIVEN, WHITE LIGHT SOURCE USING ONE OR MORE PHOSPHORS

(71) Applicant: The Regents of the University of California, Oakland, CA (US)

(72) Inventors: Ram Seshadri, Goleta, CA (US); Steven P. DenBaars, Goleta, CA (US); Kristin A. Denault, Santa Barbara, CA (US); Michael Cantore, Goleta, CA (US)

(73) Assignee: The Regents of the University of California, Oakland, CA (US)

(21) Appl. No.: 14/424,790

(22) PCT Filed: Aug. 30, 2013
(86) PCT No.: PCT/US13/57538

§ 371 Date: Feb. 27, 2015

Related U.S. Application Data
(60) Provisional application No. 61/695,120, filed on Aug. 30, 2012.

(51) Int. Cl. F21K 99/00; F21V 29/502; F21V 29/70

(52) U.S. Cl. CPC F21K 9/56; F21V 29/70; F21V 29/502; F21Y 2101/025

(57) ABSTRACT

An efficient and stable, high-power, laser-driven white light source using one or more phosphors deposited on a thermally conductive substrate that is either transparent or reflective and placed at a remote distance from the laser source. The present invention relates generally to a high-power, laser-driven, white light source using one or more phosphors.

### CROSS REFERENCE TO RELATED APPLICATIONS

This application claims the benefit under 35 U.S.C. Section 119(e) of the following co-pending and commonly-assigned patent application:

U.S. Provisional Patent Application Ser. No. 61/695,120, filed on Aug. 30, 2012, by Ram Seshadri, Steven P. DenBaars, Kristin A. Denault, and Michael Cantore, and entitled HIGH-POWER, LASER-DRIVEN, WHITE LIGHT SOURCE USING ONE OR MORE PHOSPHORS,” attorney's docket number 30794.467-US-P1 (2013-091-1);

which application is incorporated by reference herein.

This application is related to the following co-pending and commonly-assigned patent applications:

U.S. Provisional Application Ser. No. 61/723,681, filed on Nov. 7, 2012, by Kathryn M. Kelchner, James S. Speck, Nathan A. Pfaff and Steven P. DenBaars, entitled “WHITE LIGHT SOURCE EMPLOYING A III-N BASED LASER DIODE PUMPING A PHOSPHOR,” attorney's docket number 30794.471-US-P1 (2013-319-1);

U.S. Provisional Application Serial No. 61/723,683, filed on Nov. 7, 2012, by Kathryn M. Kelchner and Steven P. DenBaars, entitled “OUTDOOR STREET LIGHT FIXTURE EMPLOYING III-N BASED LASER DIODE PLUS PHOSPHORS AS A LIGHT SOURCE,” attorney's docket number 30794.472-US-P1 (2013-321-1);

U.S. Provisional Application Ser. No. 61/860,619, filed on Jul. 31, 2013, by Kristin A. Denault, Ram Seshadri and Steven P. DenBaars, entitled “LASER-DRIVEN WHITE LIGHTING SYSTEM FOR HIGH-BRIGHTNESS APPLICATIONS,” attorney's docket number 30794.524-US-P1 (2013-951-1); and

U.S. Provisional Application Serial No. 61/864,355, filed on Aug. 9, 2013, by Kristin A. Denault, Ram Seshadri and Steven P. DenBaars, entitled “PHOSPHOR COMPOSITIONS OF THE FORMULA A₃RE(BO₃)₃:Ce³⁺ (A=ALKALINE EARTH ION; RE=RARE EARTH ION) FOR SOLID STATE WHITE LIGHTING,” attorney's docket number 30794.526-US-P1 (2014-028-1);

all of which applications are incorporated by reference herein.

### BACKGROUND OF THE INVENTION

1. Field of the Invention

The present invention relates generally to a high-power, laser-driven, white light source using one or more phosphors.

2. Description of the Related Art

Prior solid-state white lighting devices typically use a light emitting diode (LED) combined with one or more phosphors to convert a portion of the LED spectrum to other wavelengths in the visible region, the combination of which appears as white light. These devices already offer many advantages over traditional incandescent and fluorescent light sources, including long lifetimes, environmentally friendly designs without the need for mercury, and enormous energy savings.

Yet, the overall efficiency of these devices can still be improved. One such example is to control the operating temperature of the device. When operating an LED, the temperature will inevitably increase, yet the phosphor particles exhibit a loss in efficiency as the temperature of the device increases. In addition, LEDs suffer from efficiency loss and color instability with increased operating current, making high-power devices not achievable using LEDs as the excitation source.

In contrast to LEDs, laser diodes do not exhibit this efficiency loss, many exhibit increased efficiency as current increases, and maintain color stability. Thus, there is a need in the art for improved solid-state white lighting devices that rely on laser diodes. The present invention satisfies this need.

### SUMMARY OF THE INVENTION

To overcome the limitations in the prior art described above, and to overcome other limitations that will become apparent upon reading and understanding the present specification, the present invention discloses a high-power, laser-driven, white light source using one or more phosphors. The result is a highly efficient and stable solid-state white lighting device that can be used for high-power applications. It features a near-ultraviolet (UV) or blue laser diode as the excitation light source and one or more phosphors deposited onto a thermally conductive substrate, that can be transparent or reflective, and placed at a remote distance from the laser source. White light is created through the combination of the near-UV or blue light emitted from the laser diode and the down-converted blue, green, yellow or red light emitted from the phosphor. In different embodiments of the art, the radiation from the laser may or may not be combined with the radiation from the phosphor or phosphors. For example, even when a blue laser diode is used, it may be advantageous to employ a blue phosphor, excited by the radiation from the laser, in order to broaden the spectral characteristics of the output light in the blue region of visible wavelengths.

Using a laser diode allows for the realization of a high power solid state white lighting device with stable color properties and no loss in efficiency at high operating currents. Phosphor particles deposited onto a thermally conductive substrate allow for dissipation of heat away from the phosphor and device, again eliminating the loss in efficiency due to increased temperature of the phosphor when operating the device. The remote phosphor geometry in conjunction with a high power laser exhibits improved efficiencies and allow these solid-state white lighting devices to be used in new applications.

### BRIEF DESCRIPTION OF THE DRAWINGS

Referring now to the drawings in which like reference numbers represent corresponding parts throughout:

FIG. 1 illustrates an experimental procedure for fabricating one possible embodiment of the present invention.

FIG. 2 is a schematic illustrating one possible configuration of the present invention.

FIG. 3 is a schematic illustrating another possible configuration of the present invention.

FIGS. 4(a)-4(e) include electroluminescence spectra collected in an integrating sphere using a blue laser, as shown in FIG. 4(a), and a near-UV laser with varying phosphor compositions, as shown in FIGS. 4(b) and 4(c).

FIGS. 4(d) and 4(e) are photographs that include the phosphor sample without laser excitation, as shown in FIG. 4(d), and the phosphor sample with laser excitation, as shown in FIG. 4(e).

FIG. 5 illustrates the CIE chromaticity coordinates for the three samples tested show white light generation on the Planckian locus of black body radiation at a variety of color temperatures. Corresponding to the graphs in FIGS. 4(a), 4(b) and 4(c), point (a) represents the blue laser device and points (b) and (c) represent the near-UV laser devices with varying phosphor compositions.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Overview

Laser diodes are used in combination with one or more phosphors to enable high power, efficient, and stable solid-state white lighting devices. A remote phosphor geometry is used with the phosphor powder deposited onto either a reflective or transparent substrate, allowing operation in either reflective or transmissive mode depending on the final application. The substrate is also thermally conductive, allowing for easy dissipation of heat away from the device, eliminating efficiency loss due to increased operating temperatures.

Laser-based devices also offer easy servicing of parts. The use of lasers with a remote phosphor configuration allows the laser to be placed at a relatively far distance from the phosphor, as would be useful in the case of street lights or stadium lighting. Lasers on the ground level, which excite phosphors placed at the point that is to be illuminated, can then easily be serviced when necessary.

An advantageous embodiment of the invention can include one or more optical elements, including appropriate refractive optics, and/or optical Bragg diffraction using gratings, so that the laser source radiation can be efficiently spread out over the phosphors, rather than be confined to a sharp point of excitation. Moreover, the surface of the phosphor coating or monolith may be shaped, patterned or roughened, in order to achieve appropriate light insertion and extraction.

Overall, this technology offers a stable, energy efficient, high power solid state white lighting device that eliminates many of the loss mechanisms that lead to decreased efficiency in LED-based white lighting devices and has the potential to be used in new areas of the lighting market.

### Technical Description

The solid state white lighting device described herein comprises a laser source optically coupled to one or more phosphors, wherein the laser source emits light in a first wavelength range that is converted to light at a range of longer wavelengths by the phosphors, and the phosphors are deposited on a substrate that is placed at a remote distance from the laser source. Specifically, the solid state white lighting device uses a near-UV or blue light emitting laser diode as an excitation source, and one or more phosphors which down-convert part or all of the near-UV or blue light to longer wavelengths, including blue, green, yellow, and red. The combination of the emitted light then appears white to the human eye, and can be tuned to the appropriate color.

The phosphor particles are set onto a substrate using an optically transparent resin or epoxy, or employed as transparent or semi-transparent monoliths or coatings. The substrate itself can be transparent or reflective, depending on final application of the device.

The substrate can be thermally conductive to dissipate heat away from the phosphor particles, eliminating efficiency loss due to increased operating temperatures. An example of such a thermally conductive substrate would be sapphire for cases where the phosphor is in a transmission geometry, and a mirror-like thermally conductive silver coating when the phosphor is employed in a reflective geometry. Moreover, the substrate may be actively or passively cooled, including thorough the use of thermo-electric materials.

The phosphor and substrate can be placed at a remote distance from the laser diode sufficient to eliminate heat transfer from the laser diode to the phosphor particles. The range of this distance can vary based on the final application of the device. The laser diode and the phosphor material may be enclosed in the same device casing, or the laser diode may be in a separate device casing from the phosphor material, allowing for a larger separation distance.

A typical experimental setup was used to measure the overall device properties, including luminous efficacy, correlated color temperature (CCT), color rendering index (Rₐ), and Commission Internationale de L'Eclairage (CIE) chromaticity coordinates.

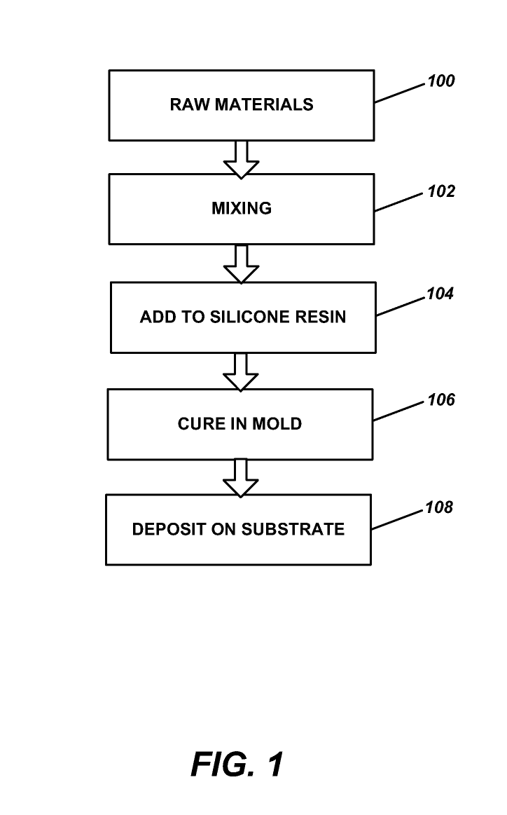

FIG. 1 illustrates an experimental procedure for fabricating one possible embodiment of the present invention.

Block 100 represents the raw materials for phosphor samples being provided.

Blocks 102 and 104 represent the phosphor samples being prepared by mixing phosphor powders into optically transparent silicone resin in a 1:1 ratio by weight. For the case of using multiple phosphors, the phosphor powders were first thoroughly mixed together in Block 102 and then added to the silicone resin in Block 104; otherwise, for the case of using a single phosphor, Block 102 may be optional.

Block 106 represents the mixtures being cured in a round pellet mold and Block 108 represents the mold being set onto a substrate.

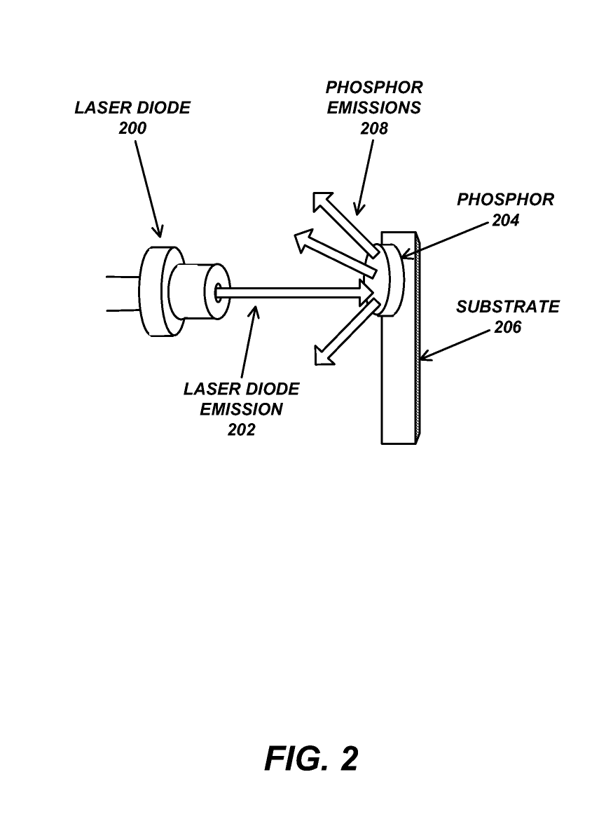

FIG. 2 is a schematic illustrating one possible configuration of the phosphor fabricated in FIG. 1. A laser diode 200 is configured such that its emission 202 is used to excite one or more phosphors 204 embedded in an optically transparent silicone resin that is shaped as a round pellet mold. The phosphor encapsulated silicone disk 204 is mounted on a transparent quartz substrate 206, and is placed at a remote distance from the laser diode 200. The phosphors 204 wavelength convert the emission 202 from the laser diode 200, resulting in phosphor emissions 208. The phosphor encapsulated silicone disk 204 is positioned on the surface of the substrate 206 at a slight angle to the incoming laser beam 202 resulting in a reflection mode for the phosphor emissions 208.

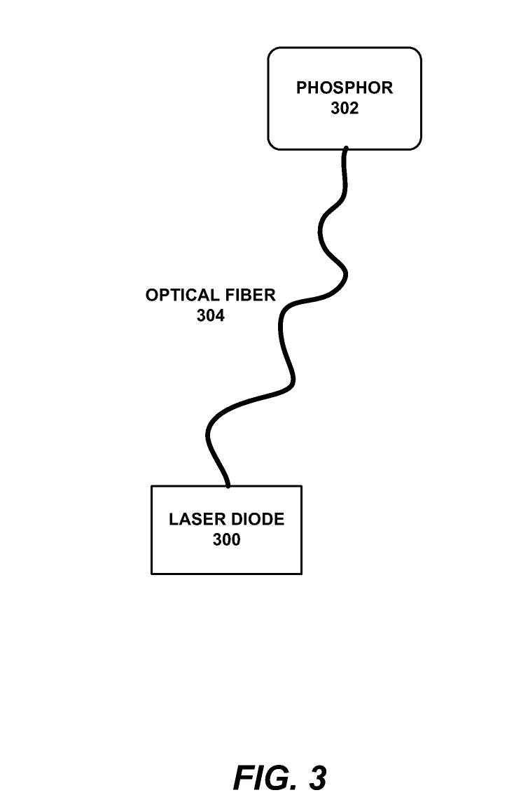

FIG. 3 is a schematic illustrating another possible configuration of the present invention. A laser diode 300 is located remotely from one or more phosphors 302 deposited on a substrate or reflector or lens. The phosphor 302 is optically coupled to the laser diode 300 by means of an optical fiber 304 or other mechanism. Like the configuration of FIG. 2, the phosphors 302 wavelength convert the emissions received via the fiber 304 from the laser diode 300.

Experimentally, an integrating sphere with a laser port was used to collect data. The phosphor samples were placed in the center of the sphere at a slight angle to the laser beam.

White light has been demonstrated using both a blue laser (with a wavelength ranging from about 400-500 nm, and most preferably about 440 nm) and a near-UV laser (with a wavelength ranging from about 300-400 nm, and most preferably about 400 nm) as the excitation source. The phosphors down-convert part or all of the light emitted by the near-UV or blue light emitting laser diode to light having longer wavelengths, including blue, green, yellow and red light, with wavelengths ranging from about 400-800 nm. Preferably, the emitted white light has a CCT ranging from about 2000-7000 K, an Rₐ ranging from about 60-100, and a luminous efficacy greater than about 15 lumens per Watt (lm/W).

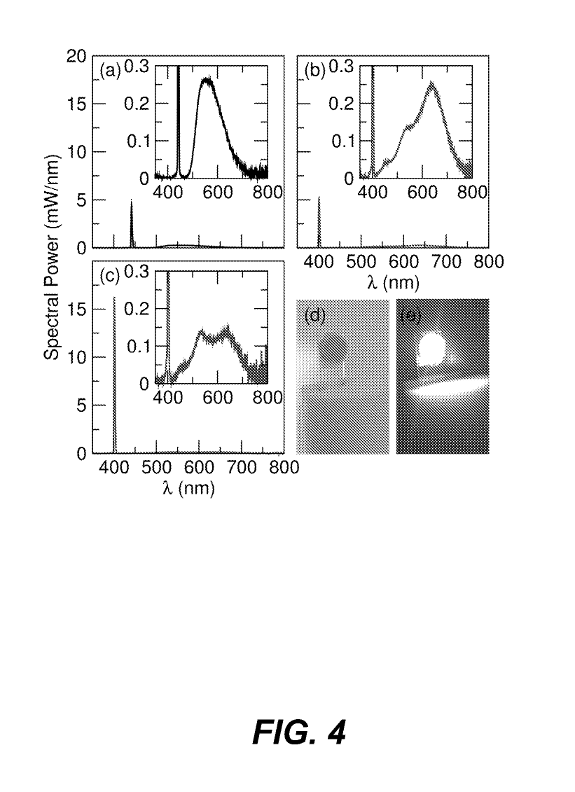

For the blue laser, a blue-excited yellow-emitting phosphor powder was used. The phosphor may comprise yellow-emitting Y₃Al₅O₁₂:Ce³⁺ (YAG:Ce). FIG. 4(a) shows the electroluminescence spectrum generated using the blue laser operating under 200 mA. A cool white light was observed with a CCT of 6000, Rₐ of 64 and luminous efficacy of 20 lm/W.

For the near-UV laser, a combination of UV-excited blue-, green-, and red-emitting phosphors were used. For example, the phosphors may comprise blue-emitting BaMgAl₁₀O₁₇:EU²⁺, green-emitting Ba₂SiO₄:Eu², and red-emitting Sr₂Si₅N₈:Eu². Two phosphor samples were made with different blue:green:red phosphor ratios to demonstrate white light at a variety of color temperatures. The phosphor samples may comprise a R:G:B weight ratio of 1.65:1:3.45 and a R:G:B weight ratio of 3.3:1:2.3. FIGS. 4(b) and 4(c) show the electroluminescence spectrum generated using the near-UV laser operating under 100 mA for the two phosphor samples. Specifically, FIG. 4(b) shows a warm white light with a CCT of 2800, Rₐ of 95 and luminous efficacy of 23 lm/W for the first phosphor sample, and FIG. 4(c) shows a white light with a CCT of 4200, Rₐof 84 and luminous efficacy of 18 lm/W for the second phosphor sample,

FIGS. 4(d) and 4(e) are photographs of the phosphor sample without laser excitation and with laser excitation, respectively.

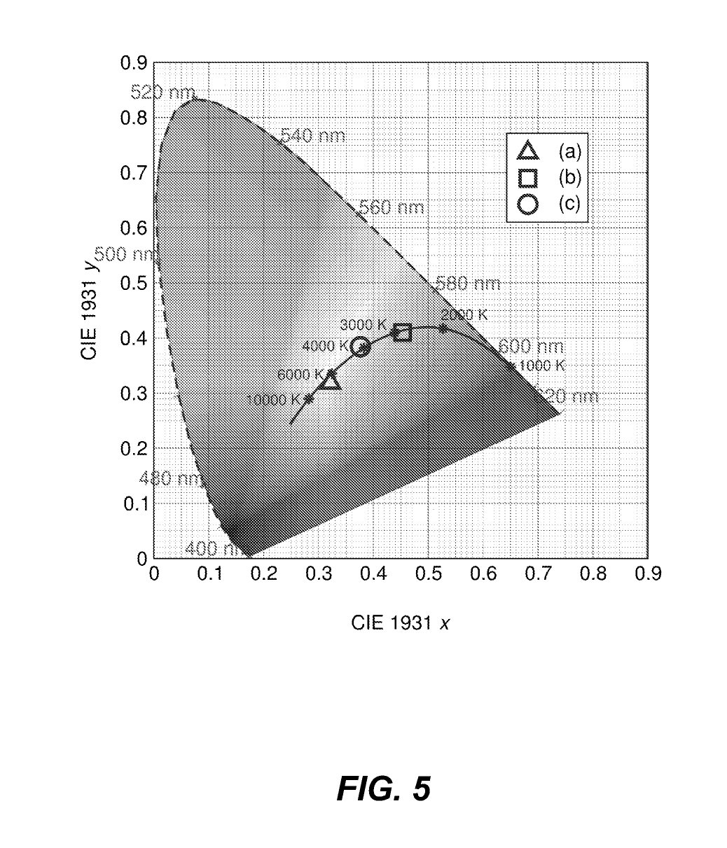

FIG. 5 illustrates the CIE chromaticity coordinates for the three samples tested, which show white light generation on the Planckian locus of black body radiation at a variety of color temperatures. Corresponding to the graphs in FIGS. 4(a), 4(b) and 4(c), point (a) (the triangle) represents the blue laser device, and points (b) (the square) and (c) (the circle) represent the near-UV laser devices with varying phosphor compositions.

Additional plans to further develop the invention include optimizing the amount of phosphor needed and the ratio of different phosphors, testing the thermal conductivity of different substrates and how this affects the device efficiency, and understanding the angular dependence of the laser beam with the phosphor sample to achieve appropriate mixing and scattering of light from different substrates. Testing of thermally conductive substrates may expand beyond thermal conductive materials to thermo-electric devices which actively cool the phosphors or to passively cool the phosphors while converting some heat energy into electrical energy which may be returned to the laser system.

### Conclusion

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An apparatus for emitting white light, comprising:
a laser source optically coupled to one or more phosphors, wherein the laser source emits light in a first wavelength range that is converted to light in a second wavelength range by the phosphors, and the phosphors are deposited on a substrate that is placed at a remote distance from the laser source.

2. The apparatus of claim 1, wherein the laser source comprises a near-ultraviolet (UV) or blue light emitting laser diode emitting in the first wavelength range from about 300 nm to about 500 nm.

3. The apparatus of claim 2, wherein the light in the second wavelength range has a longer wavelength than the light in the first wavelength range.

4. The apparatus of claim 3, wherein the phosphors down-convert part or all of the light emitted by the near-UV or blue light emitting laser diode to light having longer wavelengths, including blue, green, yellow and red light, ranging from about 400 nm to about 800 nm.

5. The apparatus of claim 1, wherein the emitted white light has a color temperature ranging from about 2000 K to about 7000 K.

6. The apparatus of claim 1, wherein the emitted white light has a color rendering index ranging from about 60 to about 100.

7. The apparatus of claim 1, wherein the emitted white light has a luminous efficacy greater than about 15 lumens per Watt.

8. The apparatus of claim 1, wherein a surface of the phosphors is shaped, patterned or roughened.

9. The apparatus of claim 1, wherein the substrate is transparent.

10. The apparatus of claim 1, wherein the substrate is reflective.

11. The apparatus of claim 1, wherein the substrate is placed at a remote distance from the laser source sufficient to eliminate heat transfer from the laser source to the phosphors.

12. The apparatus of claim 1, wherein the substrate is a thermally conductive substrate to dissipate heat away from the phosphors.

13. The apparatus of claim 1, wherein the substrate is actively or passively cooled.

14. The apparatus of claim 1, further comprising one or more optical elements coupled to the laser source for spreading out the light in the first wavelength range over the phosphors.

15. A method of emitting white light, comprising:
optically coupling a laser source to one or more phosphors, wherein the laser source emits light in a first wavelength range that is converted to light in a second wavelength range by the phosphors, and the phosphors are deposited on a substrate that is placed at a remote distance from the laser source.

16. The method of claim 15, wherein the laser source comprises a near-ultraviolet (UV) or blue light emitting laser diode emitting in the first wavelength range from about 300 nm to about 500 nm.

17. The method of claim 16, wherein the light in the second wavelength range has a longer wavelength than the light in the first wavelength range.

18. The method of claim 17, wherein the phosphors down-convert part or all of the light emitted by the near-UV or blue light emitting laser diode to light having longer wavelengths, including blue, green, yellow and red light, ranging from about 400 nm to about 800 nm.

19. The method of claim 15, wherein the emitted white light has a color temperature ranging from about 2000 K to about 7000 K.

20. The method of claim 15, wherein the emitted white light has a color rendering index ranging from about 60 to about 100.

21. The method of claim 15, wherein the emitted white light has a luminous efficacy greater than about 15 lumens per Watt.

22. The method of claim 15, wherein a surface of the phosphors is shaped, patterned or roughened.

23. The method of claim 15, wherein the substrate is transparent.

24. The method of claim 15, wherein the substrate is reflective.

25. The method of claim 15, wherein the substrate is placed at a remote distance from the laser source sufficient to eliminate heat transfer from the laser source to the phosphors.

26. The method of claim 15, wherein the substrate is a thermally conductive substrate to dissipate heat away from the phosphors.

27. The method of claim 15, wherein the substrate is actively or passively cooled.

28. The method of claim 15, further comprising one or more optical elements coupled to the laser source for spreading out the light in the first wavelength range over the phosphors.
